(19) United States
(12) Patent Application Publication
(10) Pub. No.: US 2023/0109056 A1
(43) Pub. Date: Apr. 6, 2023

(54) PET TOY

(71) Applicant: NANJING DM TECHNOLOGY CO., LTD., Nanjing (CN)

(72) Inventor: Hu YANG, Nanjing (CN)

(73) Assignee: NANJING DM TECHNOLOGY CO., LTD., Nanjing (CN)

(21) Appl. No.: 17/047,953

(22) PCT Filed: Aug. 4, 2020
(86) PCT No.: PCT/CN2020/106720

§ 371 Date: Oct. 15, 2020

(51) Int. Cl. A01K 15/02

(52) U.S. Cl. CPC A01K 15/025

(57) ABSTRACT

The present invention discloses a pet toy. A surface of a main body has a plurality of holes, and the holes are not all formed in the same horizontal plane; a guide rail layer is arranged in the main body; the guide rail layer is provided with a multi-section rod, and the multi-section rod is connected with a power unit; the multi-section rod is driven by the power unit to cooperate with the guide rail layer; when moving under the drive of the power unit with the cooperation of the guide rail layer, the multi-section rod will be guided along the guide rail layer to achieve extension; the holes in the surface of the main body of the pet toy are not all in the same horizontal plane, making the pet toy have an entertainment mode full of fun.

### TECHNICAL FIELD

The present invention relates to the field of toys, and particularly to a pet toy.

### BACKGROUND

A pet toy is a toy used for playing with a pet, is also a type of toy derived on the basis of taking the pet as a partner, and can increase communication and interaction between people and pets.

With the improvement of people's care for pets, more and more pet toys appear on the market. At present, the pet toys on the market have different shapes, so to speak, but are still dominated by static molar toys and luminous cat toys. The entertainment modes of most of the toys have not changed much, and the fun is less diversified.

### SUMMARY

To solve the above technical problem, the purpose of the present invention is to provide a pet toy with a novel entertainment mode full of fun.

To achieve the above purpose, the present invention adopts the following technical solution: a pet toy, wherein a surface of a main body thereof has a plurality of holes, and the holes are not all formed in the same horizontal plane; a guide rail layer is arranged in the main body, and the shape of the guide rail layer is correspondingly cooperated with the holes in the surface of the main body; the guide rail layer is provided with a multi-section rod, and the multi-section rod is connected with a power unit; the multi-section rod is driven by the power unit to cooperate with the guide rail layer, which can achieve extension and retraction in the plurality of holes formed in the surface of the main body.

By adopting the above technical solution, the multi-section rod is arranged on the guide rail layer, and the shape of the guide rail layer is correspondingly cooperated with the holes in the surface of the main body of the toy; when moving under the drive of the power unit with the cooperation of the guide rail layer, the multi-section rod will be guided along the guide rail layer to achieve extension or retraction in a correspondingly cooperated hole of the guide rail layer; the holes in the surface of the main body of the pet toy are not all in the same horizontal plane, which may be either in the top of the main body or in a side surface of the main body, therefore the multi-section rod can achieve the effect of extension and retraction in the holes of different dimensions, making the pet toy have an entertainment mode full of fun.

Preferably, the main body is provided with a shell.

By adopting the above technical solution, the shell can protect the main body of the toy.

Preferably, the multi-section rod is composed of a main rod, a secondary rod and a tertiary rod; one end of the main rod is rotatably connected with the power unit, and the other end thereof is hinged with one end of the secondary rod; the secondary rod can swing horizontally; the other end of the secondary rod is hinged with one end of the tertiary rod; and the tertiary rod can swing vertically.

By adopting the above technical solution, when the power unit runs, the main rod will be driven by the power unit to rotate with one end thereof connected to the power unit as an axis; as the multi-section rod is arranged on the guide rail layer, the multi-section rod can be guided by the shape of the guide rail layer; at the same time, the multi-section rod fits the guide rail layer, so a certain friction force is generated during rotation; therefore, the secondary rod will change in the horizontal direction under the influence of the shape of the guide rail layer and the friction force, and the tertiary rod will change in the vertical direction under the influence of the shape of the guide rail layer; and through the changes in the directions of the secondary rod and the tertiary rod, the whole main rod will change to be bent and straightened, so as to achieve the effect of cooperating with the guide rail layer to realize extension and retraction in each hole.

Preferably, the multi-section rod is provided with an ornament.

By adopting the above technical solution, the multi-section rod is provided with the ornament; when the multi-section rod achieves extension and retraction in each hole in the surface of the main body, the ornament will achieve extension and retraction along with the multi-section rod in the hole, which increases the fun of the pet toy.

Preferably, the power unit comprises a motor, a battery pack and an MCU micro control unit.

By adopting the above technical solution, the battery pack can provide electric power for the motor and the MCU micro control unit; the motor can rotate after being energized, and thereby realizing the drive of the multi-section rod; and the MCU micro control unit can control the rotation direction, etc. of the motor through a preset program, so that the multi-section rod driven by the motor can rotate clockwise and counterclockwise.

Preferably, the motor is provided with a deceleration mechanism.

By adopting the above technical solution, the deceleration mechanism can play a role of deceleration between the multi-section rod and the power unit, and achieve the effect of reducing the rotation speed of the multi-section rod.

Preferably, the battery pack is detachable.

By adopting the above technical solution, the battery pack can be easily replaced when a battery is exhausted or need to be replaced for other reasons.

Preferably, the surface of the main body is provided with a switch, and the switch is connected with the power unit.

By adopting the above technical solution, the on/off of the pet toy can be controlled by operating the switch.

Preferably, the guide rail layer is provided with guide rail pieces.

By adopting the above technical solution, the guide rail pieces are arranged on the guide rail layer vertically, and are further correspondingly cooperated with the holes, so that the multi-section rod can extend from the holes more accurately and efficiently.

Compared with the prior art, the present invention has the advantages that: (1) the entertainment mode is novel and full of fun; and (2) the structure does not contain excessive complicated parts, so the production cost is low.

### DESCRIPTION OF DRAWINGS

FIG. 1 is a structural schematic diagram showing a guide rail layer of embodiment 1 of the present invention;

FIG. 2 is a structural schematic diagram showing the internal surface of an upper shell of embodiment 1 of the present invention;

FIG. 3 is a structural schematic diagram showing the bottom of a guide rail layer of embodiment 1 of the present invention;

FIG. 4 is an exploded schematic diagram showing the overall structure of embodiment 1 of the present invention;

FIG. 5 is a schematic diagram showing the overall shape of embodiment 1 of the present invention;

In the figures: 1. hole; 2. multi-section rod; 201. main rod; 202. secondary rod; 203. tertiary rod; 3. guide rail layer; 301. guide rail piece; 4. motor; 5. switch; 6. MCU micro control unit; 7. pulley; 8. battery pack; 9. battery cover plate; 10. upper shell; 11. lower shell; 12. positioning column; 13. positioning hole.

### DETAILED DESCRIPTION

The present invention is further described below in detail in combination with the drawings and embodiments.

### Embodiment 1

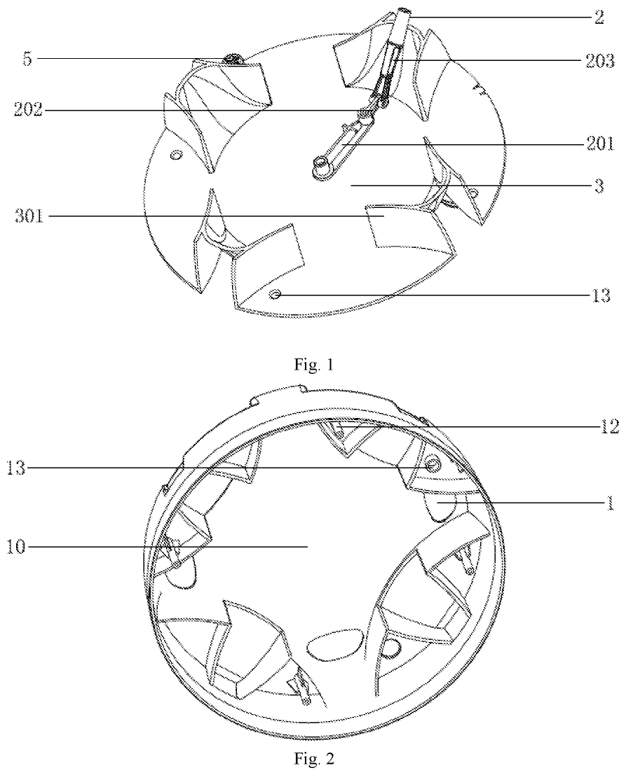

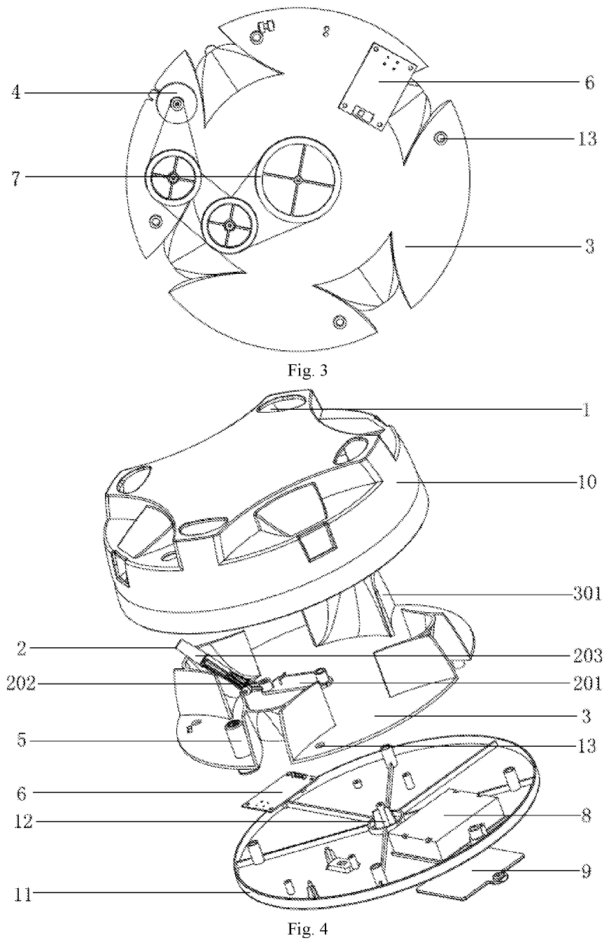

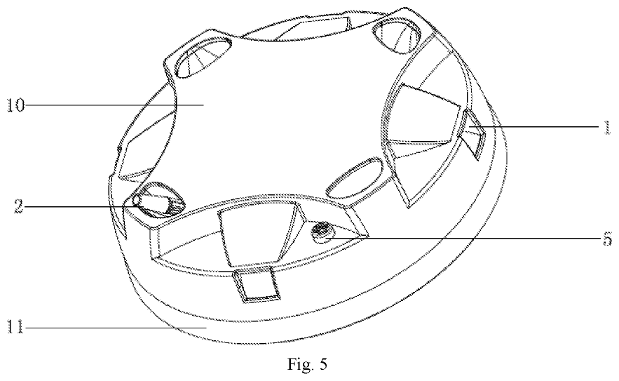

A pet toy as shown in FIGS. 1-5, wherein a surface of a main body thereof is provided with a shell; the shell can be divided into an upper shell 10 and a lower shell 11 according to the position and can protect the main body; 8 holes 1 are formed in the surface of the main body and the shell, wherein 4 holes 1 are formed in the top of the surface of the main body, and the other 4 holes 1 are formed in a side surface of the main body, i.e., in the top and the side surface of the shell; and the holes are mutually not all in the same dimension; a guide rail layer 3 is arranged in the main body, and the shape of the guide rail layer 3 is correspondingly cooperated with the holes 1 in the surface of the main body, as shown in FIGS. 1 and 3; and the guide rail layer 3 has upwardly inclined slopes corresponding to the holes 1 in the top of the surface of the main body, which can be in correspondence with the holes 1 above.

A multi-section rod 2 is arranged in the main body, as shown in FIG. 1; the multi-section rod 2 is composed of a main rod 201, a secondary rod 202 and a tertiary rod 203; one end of the main rod 201 is arranged in the center of the guide rail layer 3 and is connected with a power unit below the guide rail layer 3; the main rod 201 can be driven by the power unit to rotate with the center of the guide rail layer 3 as an axis; the other end of the main rod 201 is hinged with one end of the secondary rod 202, and the secondary rod 202 can swing horizontally around the hinging point; the other end of the secondary rod 202 is hinged with one end of the tertiary rod 203, and the tertiary rod 203 can swing vertically around the hinging point; and the other end of the tertiary rod 203 can be installed with an ornament. When the pet toy is in operation, the motion state of the multi-section rod 2 composed of the main rod 201, the secondary rod 202 and the tertiary rod 203 is that: taking FIG. 1 as a reference, the multi-section rod 2 rotates clockwise under the drive of the power unit, at this time, the main rod 201 is a first-level driven rod, and the secondary rod 202 hinged therewith under the drive thereof is a second-level driven rod; because the multi-section rod 2 is arranged to fit the guide rail layer 3, a friction force is generated between the multi-section rod 2 and the guide rail layer 3; in the case of friction force, the angle at which the secondary rod 202 rotates in the clockwise direction is smaller than the angle at which the main rod 201 rotates, so that the main rod 201 rotates and drags the secondary rod 202 to form a bending condition therebetween; at the same time, the tertiary rod 203 will retract from one hole 1 at a position corresponding to the multi-section rod 2 in FIG. 1 under the drive of the secondary rod 202, and the retracted tertiary rod 203 will fall to fit the guide rail layer 3 under the action of gravity; when the secondary rod 202 and the tertiary rod 203 rotate to a position where one end of the tertiary rod 203 is aligned with a position between two slopes of the guide rail layer 3, the power unit changes the rotation direction, and the main rod 201 rotates counterclockwise under the action thereof; when the main rod 201 rotates in the clockwise direction, the angle between the main rod 201 and the secondary rod 202 is less than 180 degrees; when the main rod 201 rotate counterclockwise, the angle between the main rod 201 and the secondary rod 202 starts to increase under the influence of the friction force, so that the multi-section rod 2 is gradually straightened, and the tertiary rod 203 can achieve extension from a corresponding hole 1 in the surface of the main body of the toy; by the same principle, when the hole 1 corresponding to the tertiary rod 203 is formed in the top of the surface of the main body, the tertiary rod 203 will move upward along one slope of the guide rail layer 3 during movement, so that the multi-section rod 2 can achieve the effect of extension from the hole 1 in the top of the surface of the main body. The principle for the multi-section rod 2 to achieve extension and retraction in other holes 1 is also the same; when the power unit rotates clockwise and counterclockwise according to a certain law, the multi-section rod 2 will also achieve extension and retraction in the corresponding holes 1 according to a certain law, so that the multi-section rod 2 can achieve the effect of extension and retraction in the holes 1 of different dimensions, making the pet toy have an entertainment mode full of fun.

In the present embodiment, one end of the tertiary rod 203 of the multi-section rod 2 is movably provided with a fish-shaped ornament; when the multi-section rod achieves extension and retraction in each hole in the main body, the ornament will achieve extension and retraction along with the multi-section rod in the hole, which increases the fun of the pet toy.

In the present embodiment, the power unit is composed of a motor 4, a battery pack 8 and an MCU micro control unit 6; the motor 4, the battery pack 8 and the MCU micro control unit 6 are all located between the guide rail layer 3 and part of the main body corresponding to the lower shell 11, as shown in FIGS. 3 and 4; the motor 4 is arranged on the bottom surface of the guide rail layer 3; the MCU micro control unit 6 is also arranged on the bottom surface of the guide rail layer 3, and is connected with the motor 4 in control; and battery pack 8 is electrically connected with the motor 4 and the MCU micro control unit 6 through a circuit.

In the present embodiment, the motor 4 is provided with a deceleration mechanism; the deceleration mechanism is interposed between the motor 4 and the multi-section rod 2 to play a role of deceleration, as shown in FIG. 3 in details; the deceleration mechanism is composed of a group of pulleys 7; one of the pulleys 7 in the group is arranged at the center of the guide rail layer 3, and is corresponding to the multi-section rod 2 on the front surface of the guide rail layer 3; the rotation of one of the pulleys 7 can drive the main rod 201 of the multi-section rod 2 to rotate; the smallest pulley 7 in the group of pulleys 7 is arranged on the motor 4, and is cooperated with the motor 4; when the motor 4 rotates, the smallest pulley 7 will follow the motor 4 to rotate; then under the drive of a belt, the other pulleys 7 will rotate accordingly, and finally a driving force is transmitted to the multi-section rod 2 through the pulleys 7; since the driving force is reduced by the pulleys 7, the effect of reducing the rotation speed of the multi-section rod 2 is achieved.

In the present embodiment, the MCU micro control unit 6 can preset a program, and is connected with the motor 4 in control, so that the motor 4 can rotate clockwise and counterclockwise intermittently and regularly.

In the present embodiment, the battery pack 8 is detachable, as shown in FIG. 4; a battery cover plate 9 is arranged at the bottom of the main body corresponding to the bottom surface of the lower shell 11; the battery cover plate 9 is detachably arranged at the bottom of the main body; and the battery pack 8 can be exposed by opening the battery cover plate 9, so as to achieve the purpose of detaching and replacing the battery pack 8.

In the present embodiment, the surface of the main body is provided with a switch 5 which is connected with the power unit, as shown in FIG. 4 in details; an opening is formed in the top of the surface of the main body, i.e., the top of the shell; the switch 5 is arranged corresponding to the opening, and the switch 5 can penetrate through the opening to be exposed on the surface of the main body; one end of the switch 5 is installed on the guide rail layer 3; the MCU micro control unit 6 is arranged on the back of the guide rail layer 3 at a position corresponding to the switch 5; and the switch 5 is connected with the MCU micro control unit 6 in control through the guide rail layer 3, so that the MCU micro control unit 6 can be controlled by operating the switch 5, and then the whole power unit is controlled by the MCU micro control unit 6, thus achieving the effect of controlling the on/off of the pet toy by the switch 5.

In the present embodiment, as shown in FIG. 1, the guide rail layer 3 is provided with guide rail pieces 301; the position of each guide rail piece 301 is corresponding to each hole 1; the guide rail pieces 301 are arranged on the guide rail layer 3 vertically, and can further intervene with the multi-section rod 2 in the horizontal direction, so that the extension and retraction of the multi-section rod 2 will be more accurate under the intervention thereof, and the extension and retraction in the holes 1 can be achieved more effectively.

In the present embodiment, as shown in FIGS. 1-4, the internal surface of the main body corresponding to the upper shell 10 and the lower shell 11 as well as the front and back surfaces of the guide rail layer 3 are all provided with positioning columns 12 and have positioning holes 13 corresponding to the positioning columns 12; and through the cooperation of the positioning columns 12 and the positioning holes 13, the structural stability of the pet toy can be ensured after assembly.

In the present embodiment, the length of the multi-section rod 2 in straightened state is 0.5 cm beyond the hole 1 farthest from the center point of the guide rail layer 3. It should be noted that when the height of part of the main body corresponding to the upper shell 10 is relatively large, the distance from the hole 1 formed in the top edge of the main body to the center point of the guide rail layer 3 will be longer than the distance from the hole 1 formed in the side surface of the main body to the center point of the guide rail layer 3.

### Embodiment 2

The present embodiment is different from embodiment 1 in that: in the present embodiment, the length of the multi-section rod 2 in straightened state is 1 cm beyond the hole 1 farthest from the center point of the guide rail layer 3.

In the present embodiment, one end of the multi-section rod 2 extending from the hole 1 is movably provided with a feather ornament. The feather ornament is more attractive to cats, and at the same time, the extension and retraction increase the fun.

### Embodiment 3

The present embodiment is different from embodiment 1 in that: in the present embodiment, the length of the multi-section rod 2 in straightened state is 0.2 cm beyond the hole 1 farthest from the center point of the guide rail layer 3.

In the present embodiment, one end of the multi-section rod 2 extending from the hole 1 is movably provided with an animal-shaped ornament, and at the same time, the extension and retraction increase the fun.

Although preferred embodiments of the present invention are described in detail above, it should be understood that for those skilled in the art, various variations and changes can be made to the present invention. Any modification, equivalent replacement, improvement, etc. made within the spirit and the principle of the present invention shall be included within the protection scope of the present invention.

What is claimed is:

1. A pet toy, wherein a surface of a main body thereof has a plurality of holes (1), and the holes (1) are not all formed in the same horizontal plane; a guide rail layer (3) is arranged in the main body, and the shape of the guide rail layer (3) is correspondingly cooperated with the holes (1) in the surface of the main body; the guide rail layer (3) is provided with a multi-section rod (2), and the multi-section rod (2) is connected with a power unit; the multi-section rod (2) is driven by the power unit to cooperate with the guide rail layer (3), which can achieve extension and retraction in the plurality of holes (1) formed in the surface of the main body.

2. The pet toy according to claim 1, wherein the main body is provided with a shell.

3. The pet toy according to claim 1, wherein the multi-section rod (2) is composed of a main rod (201), a secondary rod (202) and a tertiary rod (203); one end of the main rod (201) is rotatably connected with the power unit, and the other end thereof is hinged with one end of the secondary rod (202); the secondary rod (202) can swing horizontally; the other end of the secondary rod (202) is hinged with one end of the tertiary rod (203); and the tertiary rod (203) can swing vertically.

4. The pet toy according to claim 1, wherein the multi-section rod (2) is provided with an ornament.

5. The pet toy according to claim 1, wherein the power unit comprises a motor (4), a battery pack (8) and an MCU micro control unit (6).

6. The pet toy according to claim 5, wherein the motor (4) is provided with a deceleration mechanism.

7. The pet toy according to claim 5, wherein the battery pack (8) is detachable.

8. The pet toy according to claim 1, wherein the surface of the main body is provided with a switch (5), and the switch (5) is connected with the power unit.

9. The pet toy according to claim 1, wherein the guide rail layer (3) is provided with guide rail pieces (301).
